(19) United States
(12) Patent Application Publication
(10) Pub. No.: US 2014/0317389 A1
(43) Pub. Date: Oct. 23, 2014

(54) COMPUTATIONAL SPRINTING USING MULTIPLE CORES

(71) Applicants: The Regents of the University of Michigan, Ann Arbor, MI (US); The Trustees Of The University of Pennsylvania, Philadelphia, PA (US)

(72) Inventors: Thomas F. Wenisch, Ann Arbor, MI (US); Kevin Pipe, Ann Arbor, MI (US); Marios Papaefthymiou, Ann Arbor, MI (US); Milo M.K. Martin, Philadelphia, PA (US); Arun Raghavan, Philadelphia, PA (US)

(73) Assignee: The Trustees Of The University Of Pennsylvania, Philadelphia, PA (US)

(21) Appl. No.: 14/356,573

(22) PCT Filed: Nov. 16, 2012
(86) PCT No.: PCT/US2012/065654

§ 371 Date: May 6, 2014

Related U.S. Application Data
(60) Provisional application No. 61/561,818, filed on Nov. 18, 2011.

(51) Int. Cl. G06F 9/48; G06F 9/38

(52) U.S. Cl. CPC G06F 9/4893; G06F 9/3885
USPC 712/229

(57) ABSTRACT

A multi-core processing system that uses computational sprinting to generate high levels of computational output for short periods of time at power consumption levels that are not sustainable over longer periods of time due to thermal and/or other constraints. This is done using a number of processing cores that, when operated simultaneously, utilize available thermal capacity within the system to consume power and produce heat that is in excess of a thermal design power (TDP) of the system, but is tolerable because of the short period of operation. The system and/or method described herein may include thermal capacitors in the form of phase change materials (PCMs), may implement normal, sprint and/or cooling modes of operation, and may employ parallel sprinting, frequency sprinting, sprint pacing and/or sprint-and-rest techniques, to cite several possibilities.

### TECHNICAL FIELD

This invention relates to circuitry and methods for activating and deactivating individual cores of a multi-core processing system based on computational need.

### BACKGROUND OF THE INVENTION

Technology trends suggest that in the future, although transistor dimensions will likely continue to scale down, power density will grow with each technology generation at a rate that will outstrip improvements in the ability to dissipate heat. This conundrum has led some researchers and industry observers to predict the advent of so-called “dark silicon” (those portions of a multi-core chip that must be powered off at any given time due to thermal constraints). Thermal constraints can be particularly acute in hand-held and mobile devices that are restricted to passive cooling.

Many interactive applications are characterized by short bursts of intense computations followed by idle periods where a chip is waiting for user input. Media-intensive mobile applications, such as mobile visual search, handwriting and character recognition, and augmented reality, for example, typically fit this pattern. Periods of intense computations, such as these, usually result in a corresponding increase in the amount of heat generated by the chip.

Accordingly, it can be challenging to provide a chip, like a multi-core chip used in a mobile device to process computationally intensive applications, that both exhibits a desired responsiveness or performance and adheres to thermal constraints of the system.

### SUMMARY OF THE INVENTION

According to one aspect, there is provided a method of activating cores in a multi-core processing system. The method may comprise the steps of: processing one or more tasks while operating in a first mode by using a subset of a plurality of processing cores that are part of the multi-core processing system; operating in a second mode by using additional cores from the plurality of processing cores, the additional cores are operated in response to an increased computational requirement such that heat produced by the operating cores when running in the second mode is in excess of one or more thermal constraints of the system; and terminating the second mode of operation based at least in part on a thermal condition.

According to another aspect, there is provided a multi-core processing system, comprising: a plurality of processing cores disposed together in a common package having a thermal interface for drawing heat from the package and having external leads for electrical connection to external circuitry, wherein the cores are thermally coupled to the thermal interface of the package; and core control circuitry coupled to at least some of the cores for selectively activating and deactivating the coupled cores. The package has an associated thermal design power (TDP) that is less than a combined power consumption of the plurality of cores when executing simultaneously for an extended amount of time. The control circuitry operates to utilize a subset of the cores for regular continuous operation at a level of power consumption that is less than the TDP and, during periods of increased computational needs, operates to selectively activate additional ones of the cores at a total combined power consumption level that is in excess of the TDP and for a period of time that is limited such that the power consumption of the package does not exceed the TDP.

### BRIEF DESCRIPTION OF THE DRAWINGS

Preferred exemplary embodiments will hereinafter be described in conjunction with the appended drawings, wherein like designations denote like elements, and wherein:

FIG. 1 is a schematic view of an exemplary multi-core processing system having multiple cores integrated on a single die, where the die is thermally coupled to a thermal capacitor and a thermal interface;

FIGS. 2-6 are schematic views of other exemplary multi-core processing systems, where one or more dies are thermally coupled to one or more phase-change materials (PCMs);

FIG. 7 is a schematic view of another exemplary multi-core processing system integrated in a phone or other mobile device, where the thermal capacitor is external to the integrated circuit (IC) package;

FIG. 8 is a schematic view of another exemplary multi-core processing system, where the IC package includes sprint control circuitry and is coupled to several external circuits and power sources;

FIG. 9 is a schematic view of an exemplary sprint control circuitry, such as the one illustrated in FIG. 8, and some of its corresponding inputs and output; and

FIG. 10 is a flowchart illustrating some of the steps of an exemplary method for carrying out sprint mode operation.

### DETAILED DESCRIPTION OF THE PREFERRED EMBODIMENTS

Described herein are methods and devices that utilize computational sprinting wherein a multi-core processing system is implemented using an integrated circuit (IC) package that is able to operate in a sprint mode to carry out high levels of computational tasks for short intervals at power consumption levels that are not sustainable over longer periods of time due to thermal and/or electrical constraints of the system. This is done using a plurality of cores that, when operated simultaneously, utilize available thermal capacity within the system to consume power and produce heat in excess of a thermal design power (TDP) of the device. TDP is the maximum amount of power that is expected to be heat removed from a processing device package via its thermal interface. The amount of power consumed by the device may be used in comparison to the TDP to determine if it is operating at a sustainable level below TDP or at an unsustainable level above TDP. Thus, for example, for an IC package having sixty-four cores each consuming 2 Watts maximum when operating and an overall device TDP of 8 Watts, running more than 4 of the cores simultaneously for sustained periods of time will exceed the TDP of the device.

The methods and devices described herein run in a first mode using a subset of the cores to operate within the TDP of the device, but switch to a second mode in which additional cores are operated for a brief period of time (typically sub-second) such that the device during that period of time consumes power in excess of the TDP, yet does not exceed an unsafe temperature due to absorption of the excess heat by thermal capacitance within the system. “Thermal capacitance,” as used here, generally refers to a material's ability to buffer thermal energy as the temperature of the material rises and to subsequently dissipate the buffered thermal energy to its surroundings. The first mode may be a normal operational mode of the device, whereas the second mode is a sprint mode that provides high computational capability. Termination of the second mode before an unsafe condition occurs may be done based on a determined thermal condition of the device. The subset of the cores used in the first mode may be, for example, a single core, two cores, or some selected fraction of the total cores. The additional cores used in the sprint mode may comprise all of the remaining cores or some other number in excess of what is used in the normal mode and/or in excess of what can be handled thermally by the device over extended periods of time. Following the sprint mode, a cooling down period allows the excess heat to be dissipated, and this may be implemented by operating in the normal mode or by switching to a third, cooling mode that limits operation to something less than the normal mode to shorten the amount of time needed to dissipate the excess heat.

Initiation, management, and termination of the sprint mode may be carried out in a variety of different ways that permit the device to account for various operational parameters, such as (1) the sufficiency of available electrical power to satisfy the transient power consumption required for the sprint mode, and (2) available thermal capacity which permits the increased power consumption during the short sprint mode interval without overheating of the device. By utilizing many cores during the sprint mode for a short interval, bursts of increased computational workloads may be processed quickly and in many cases without frequency throttling or voltage scaling being needed to avoid overheating; although, such techniques may be used as well. The sprint mode may utilize a parallel sprinting technique that activates additional cores in order to produce increased computational output, a frequency sprinting technique that boosts the frequency and/or voltage of the active cores to increase the computational output of the system, or a combination thereof. The sprint mode described herein encompasses all forms of computational sprinting that involve the activation of additional logic in order to provide increased computational output for short durations at levels that are generally not sustainable indefinitely due to one or more thermal constraints on the system.

End-use applications of the methods and devices disclosed herein include battery powered mobile devices such as mobile phones, tablets, notebooks and laptops. These devices may have thermal/cooling constraints and run interactive software, which may benefit from the improved responsiveness that the sprint mode offers. Other end-use applications include desktop and other fixed or non-portable computers that utilize utility-sourced power, as well as servers and other network and data center equipment. In large data centers, servers may often undergo large swings in utilization from periods of relative quiescence to short bursts of computationally demanding processing. The responsiveness provided by the sprint mode operation using a large increase in operating cores (e.g., a 10 fold increase or more) may benefit this variable server utilization. Game consoles and set-top boxes are another application in which the methods and devices disclosed herein are applicable.

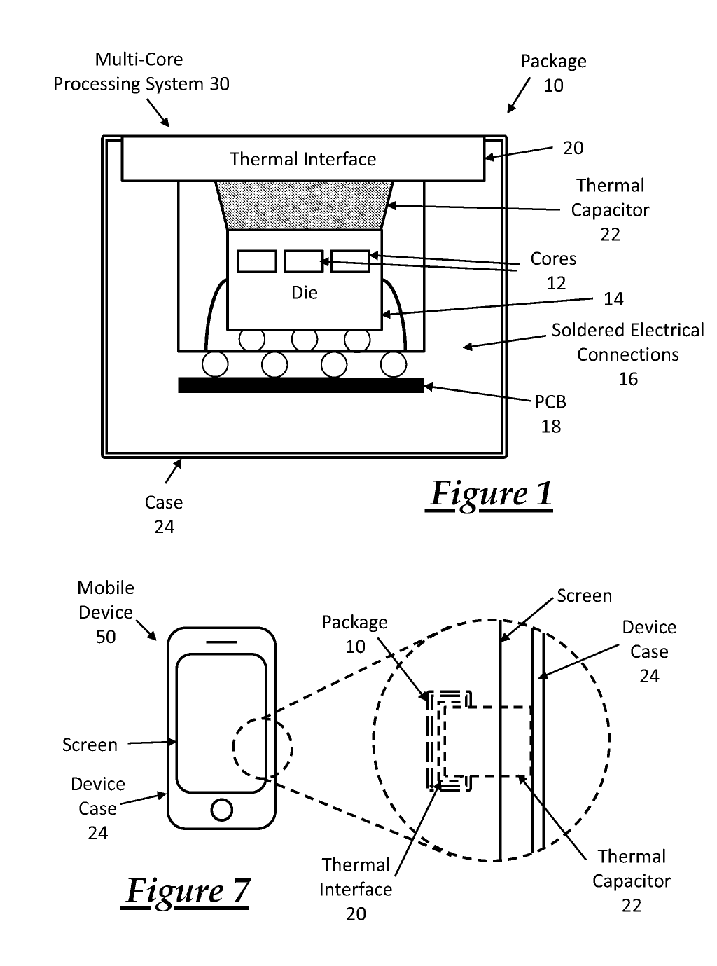

FIG. 1 diagrammatically depicts a discrete electrical device comprising an integrated circuit (IC) package 10 containing multiple processing cores 12 fabricated together on a die 14 that is surface mounted via solder connections 16 to a printed circuit board (PCB) 18 located within the package. The die 14 is thermally coupled to a thermal interface 20 of the package 10 via at least one thermal capacitor 22. The thermal interface 20 may be a metal plate like a heat spreader or other thermally conductive component located entirely within a case 24 of the IC package 10 or, as shown, may be mounted flush with the case 24 so as to provide an exposed surface having high thermal conductivity that permits direct heat sinking via the exposed surface. The thermal capacitor 22 may be located in series in the thermal path between the die 14 and the thermal interface 20 or, in other embodiments, may instead be at least partially outside this thermal path such that there is direct thermal coupling between the die 14 and the thermal interface 20. In yet other embodiments, the thermal capacitor 22 may be external to the package 10; for example, by being incorporated into the end use portable or non-portable device either in direct thermal connection to the package or indirectly via one or more other components. Other arrangements are certainly possible.

Each core 12 is a discrete processing unit or functional unit capable of executing computer readable instructions received by the device and/or stored thereon, such as instructions that are part of stored programs. Some non-limiting examples of different types of cores include: graphics processing units, specialized functional units, application-specific functional units, accelerators, offload engines, reconfigurable fabrics, as well as any other processing element that may be incorporated on a mobile or other chip. Multiple cores 12 interconnected for coordinated operation are part of a multi-core processing system 30 in which at least some of the cores may be selectively activated and deactivated according to computational demand or desire. The three cores 12 shown are just representative of a number of the processing cores. In some embodiments, only a few such cores may be utilized. Other embodiments may utilize a dozen or more up to several dozen, or even numbering over a hundred or greater. The cores 12 may be fabricated on the same integrated circuit chip (die) 14, on separate dies together in a common thermal package, or separately packaged and connected via external leads. For example, where sixty-four cores 12 are used, in one embodiment all sixty-four cores may be integrated together on a single IC chip or die 14. In another embodiment, each of the sixty-four cores 12 may be a separate chip 14 and electrically and thermally connected together in a single thermal package 10, or each separately packaged and electrically connected together via external leads. In yet another embodiment, some of the cores 12 may be grouped together into a single IC 14 and/or thermal package 10, and then the different grouped ICs electrically connected via external leads. As one example of this latter arrangement, four packages of sixteen-core ICs could be used. Various other combinations and implementations will become apparent to those skilled in the art.

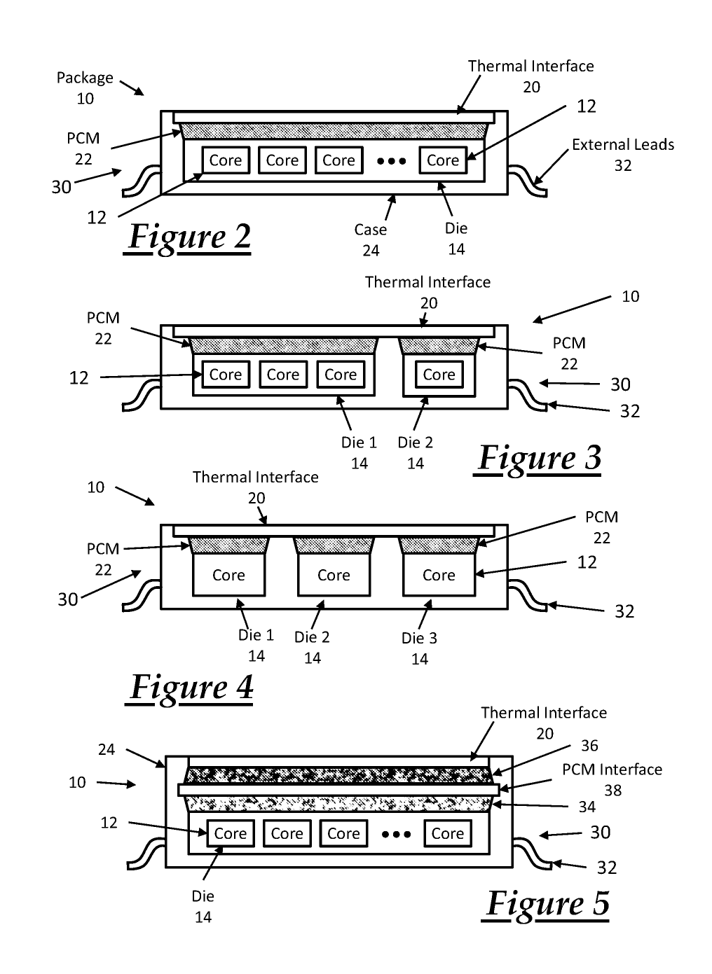

Examples of some of these various configurations are shown in FIGS. 2-4, wherein each package 10 has a plurality of cores 12 disposed on one or more dies 14 that are thermally coupled to a thermal interface or heat sink 20 via a thermal capacitor 22. The package 10 also includes external leads 32 in the case whereby the package comprises a single electrical component such as a surface mount device that may be connected to a PCB as a part of a mobile or fixed processing device such as a mobile phone, tablet, notebook, laptop, desktop computer, server, network equipment, appliance, or any other machine or apparatus requiring digital processing capability. Any desired type of processing core 12 may be used including general-purpose cores, specialized cores such as for graphics or media processing, hybrid or heterogenous multi-cores, or any other specialized function processing unit. The thermal capacitor 22 may be a phase change material (PCM) or other suitable material with thermal capacitance, or may comprise bulk thermal capacitance provided by other portions of the package without the use of a specifically added component such as the PCM. The PCM may be implemented in various ways, such as by a solid to liquid PCM having a suitable melting point that permits it to absorb heat produced by the cores 12. Whether using a PCM or other material to add thermal capacitance to the IC device, the material(s) selected may preferably have a high specific heat, such as metals or solid compounds such as ceramics that are engineered for this purpose. Materials with a high latent heat may also be used, such as PCM materials such as Icosane, that melts or otherwise phase changes during the sprint mode, but resolidify when the device is idle. Other options include solid-solid crystalline-to-amorphous compounds like polyurethane, or compounds that affect states of matter within the heat dissipation envelope of the computational sprinting. Other suitable materials may include one that provide for heat transfer from the cores 12 to the thermal capacitor(s) 22. Examples include metallic/diamond microchannels or fiber mesh carriers enhanced for thermal conductivity.

In FIG. 5 there is shown an embodiment in which a plurality of cores 12 on a single die 14 are thermally coupled to the thermal interface 20 at the surface of the package 10 via two different thermal capacitors, one using a first phase change material 34, and the second a different phase change material 36. The two thermal capacitors 34, 36 can be physically connected together in series or in parallel or can include an intervening PCM interface 38 as shown, such as a metal layer or other thermally conductive material. In some embodiments, the two phase change materials 34, 36 may have different melting points. For example, the PCM 34 closest to the die 14 may have a higher melting point selected so as to keep the die cool enough to continue functioning correctly. The PCM 36 furthest away from the die 14 may be connected to or integrated as part of the case 24 or just below the thermal interface 38 as shown, with a melting point that is set based on maximum designed temperature for the package 10. This might depend on the ultimate device application such that, for example, use in a server might permit a higher tolerable external temperature of the package versus a handheld mobile phone application. An advantage of using this second thermal capacitor, either as PCM 36 or some other thermal storage, is that it helps permit the cores 12 to be maintained at a temperature cool enough for their operation, but that is higher in temperature than is desired for the package 10 itself, with the PCM 36 absorbing heat and preventing a temperature spike as the heat trapped by PCM 34 traverses to the case 24.

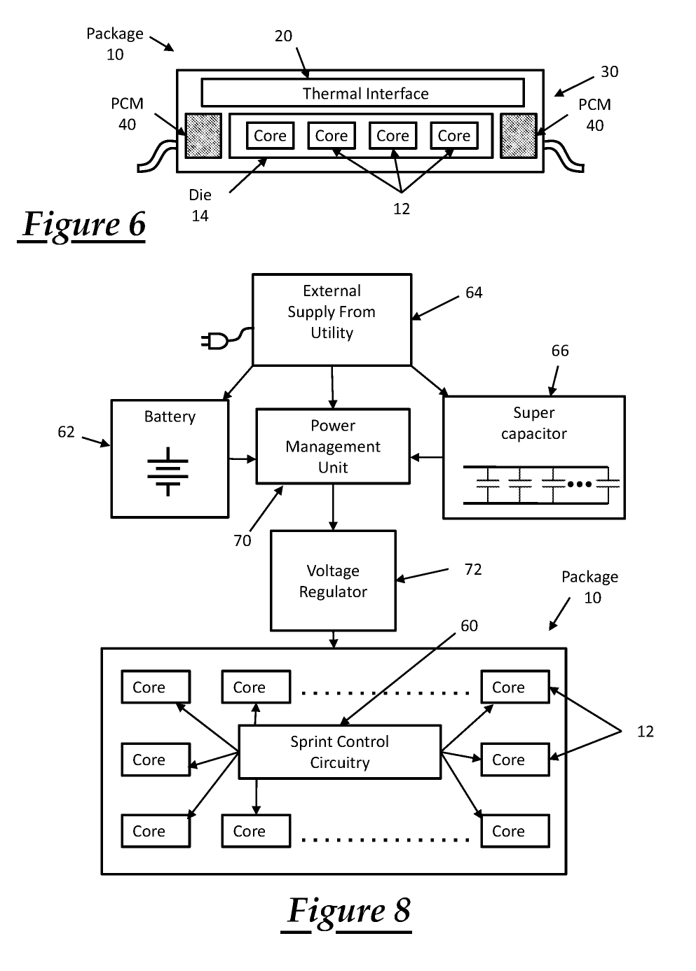

In some applications, particularly mobile devices like phones and tablets where the physical thickness of the package is an important design criteria, it may be desirable to provide a thermal capacitor where one or more phase change materials (PCMs) are installed or otherwise provided around the IC chip or die. With reference to FIG. 6, there is shown an example of a package 10 where one or more PCMs 40 surround or at least partially surround one or more dies 14. By placing the PCM 40 around the die 14, as opposed to stacking the PCM on top of or below the die, the overall thickness of the package 10 can be kept to a minimum. This type of configuration may increase the lateral dimensions of the package 10, while minimizing its thickness dimensions; an arrangement that is preferable for many mobile devices where the thickness of the device is important. Again, the particular design criteria of the application may dictate such dimensions and determine if a PCM or other thermal capacitor should be stacked on top of or below the die, located on the sides of the die, or a combination of both arrangements.

As noted above, the thermal capacitor, or one or more of the thermal capacitors in the case of two or more total, may be located external to the IC package 10. An example of this is shown in FIG. 7 where a mobile device 50 comprising a cell phone includes the IC device internally with a thermal capacitor 44 thermally coupled between the IC package 10 and the mobile device case 24. As depicted in the enlarged internal portion of the mobile device and shown in broken lines, the package 10 may have a thermal interface 20 (for good heat dissipation or heat spreading) with the thermal capacitor 44 being thermally coupled either directly or indirectly to that thermal interface. Also as shown, the thermal capacitor 44 may be connected to the device case 24, a heat sink, or otherwise internally within the mobile device case, as appropriate for a particular end use application. In some embodiments, this thermal capacitor 44 may be the only one used. In other embodiments, the IC package 10 may have both an internal thermal capacitor, such as thermal capacitor 22 shown in FIGS. 2-4 and an external thermal capacitor 44, such as shown in FIG. 7. PCM materials may be used for one or both of these thermal capacitors, including the relative melting or other phase change temperatures, as discussed above in connection with FIG. 5. In each of the preceding embodiments, the multi-core processing system 30 may include any combination of system components, including packages 10, cores 12, dies 14, connections 16, circuit boards 18, thermal interfaces 20, thermal capacitors 22, phase change materials 22, 34, 36, 40, cases 24, leads 32, phase change interfaces 38 and/or any other suitable system component.

However the IC device is implemented, it is operated as needed or desired in the first, normal mode and in the second, sprint mode to run in a lower power mode during periods of latency or reduced computational workload, and then to respond to bursts of higher computational demand by operating in the sprint mode using additional cores at a higher power consumption level to provide a high degree of responsiveness. As noted above, the normal mode is a sustained operational mode wherein the device operates at a level below its TDP, such that heat produced by the device while in this first mode can be dissipated from the device via a thermal interface or other thermal path from the cores to the package's surrounding environment. This first mode may involve operating a subset of the total number of cores, such as operating one or two cores of a sixty-four core chip, or by operating a larger number or all of the cores at a lower power level using, for example, frequency or voltage scaling. When activated, the sprint mode operates many or all of the cores at a level such that the total heat produced by all of the operating cores is in excess of the TDP of the device. This sprint mode may then continue until the increased computational demand is satisfied or until the thermal capacity is used up.

In some embodiments, the sprint mode may be initiated, controlled and/or terminated based on environmental factors, computational factors, or a combination thereof. Some non-limiting examples of potential environmental factors that may be used by the system to govern sprint mode operation include: available thermal capacity in the system, temperature of one or more system components, existence and sufficiency of electrical power supplies, etc. Computational factors generally pertain to the characteristics or nature of the tasks being processed; that is, the workload. For instance, the degree of available parallelism in the workload, the estimated duration of the workload, and the overall computational needs of the workload are several examples of potential computational factors that could be considered. Additional environmental and computational factors are discussed later on, for example, in connection with different sprint pacing techniques. Furthermore, the degree of increased computation carried out while in the sprint mode may be fixed (e.g., identical each time the sprint mode is run) or may be dependent on other factors such as the operational parameters noted above. Thus, for example, in some embodiments, the sprint mode may run all cores full out as needed until either the tasks are complete or the thermal capacity is expended, or might determine at the start of the sprint mode whether to run some or all cores based on, for example, available thermal capacity and/or characteristics of the available power such as battery state of charge or the presence or absence of utility power rather than battery power. As described below in greater detail, the sprint mode may utilize any suitable combination of parallel sprinting, frequency sprinting, predictive sprint pacing, adaptive sprint pacing and/or sprint-and-rest techniques, including using any of these techniques by themselves or in combination with other techniques.

These and other aspects of the mode control of the IC device may be implemented using core (sprint) control circuitry that in at least some embodiments is resident on the chip(s) 14 containing the cores 12 or is otherwise located within the IC package 10. FIG. 8 depicts an example of this wherein the IC device is shown with its cores 12 and the sprint control circuitry 60. Connected to the IC device are external circuits 70, 72 and power sources 62, 64, 66. In some embodiments, conventional power sources and power management approaches may be used to provide the needed normal and sprint mode power to the device. In other embodiments, a more specialized arrangement may be used to ensure sufficient boost power during the sprint mode intervals. Thus, as shown, in addition to typical supplies such as a rechargeable battery 62 and utility line power 64 (e.g., via a wall plug AC-DC adapter), power may also be supplied from a high energy density, low source impedance auxiliary source such as a supercapacitor 66. As used herein, supercapacitor includes ultracapacitors and may be, for example, an electric double-layer capacitor made from a suitable material such as nanoporous powdered activated carbon. Such capacitors are commercially available. Other power sources may be used in lieu of or in addition to those shown, for example, a fuel cell or in-package sources of charge, such as electrical capacitors.

Apart from the power sources themselves, the external circuitry includes a power management unit (PMU) 70 that supplies power from one or more of the sources to the IC device via a voltage regulator 72, which may or may not be an integral part of the power management unit. The power management unit 70 may be implemented in various ways to route power from the one or more available sources 62, 64, 66 to the IC package 10. In some embodiments, the PMU 70 implements a prioritized selection among the connected sources so that, for example, power from the utility 64 is routed to the IC package 10 if available and, if not, then from the battery 62 if it is available and is at a sufficient state of charge and, if not, then from the supercapacitor 66. Other suitable power source utilizations will be known or will become apparent to those skilled in the art. The PMU 70 may run autonomously or may receive a control or status output from the IC device that the PMU uses to select among the available sources of power. In one embodiment, upon initiating the sprint mode, the sprint control circuitry 60 sends a signal to the PMU 70 which causes it to provide power from the supercapacitor 66 to thereby help ensure that the cores 12 receive sufficient instantaneous power to all operate simultaneously. The supercapacitor 66 may thereafter be recharged from the utility 64 and/or battery 62.

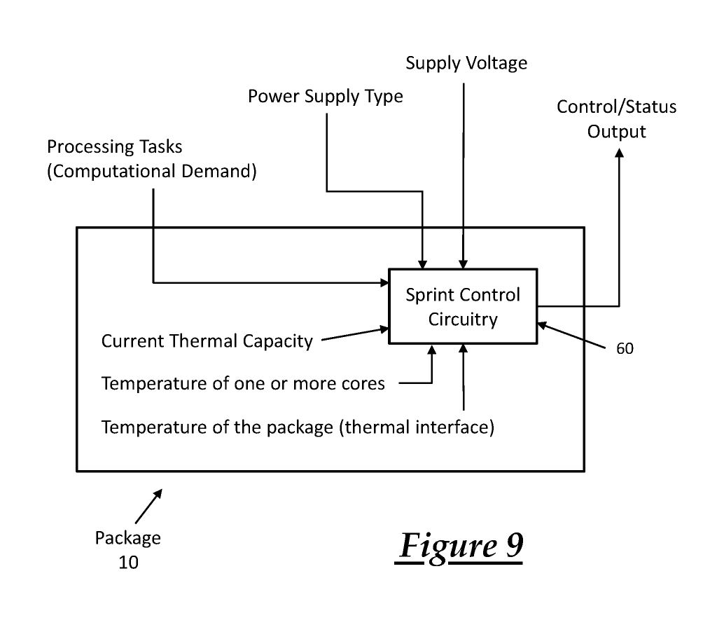

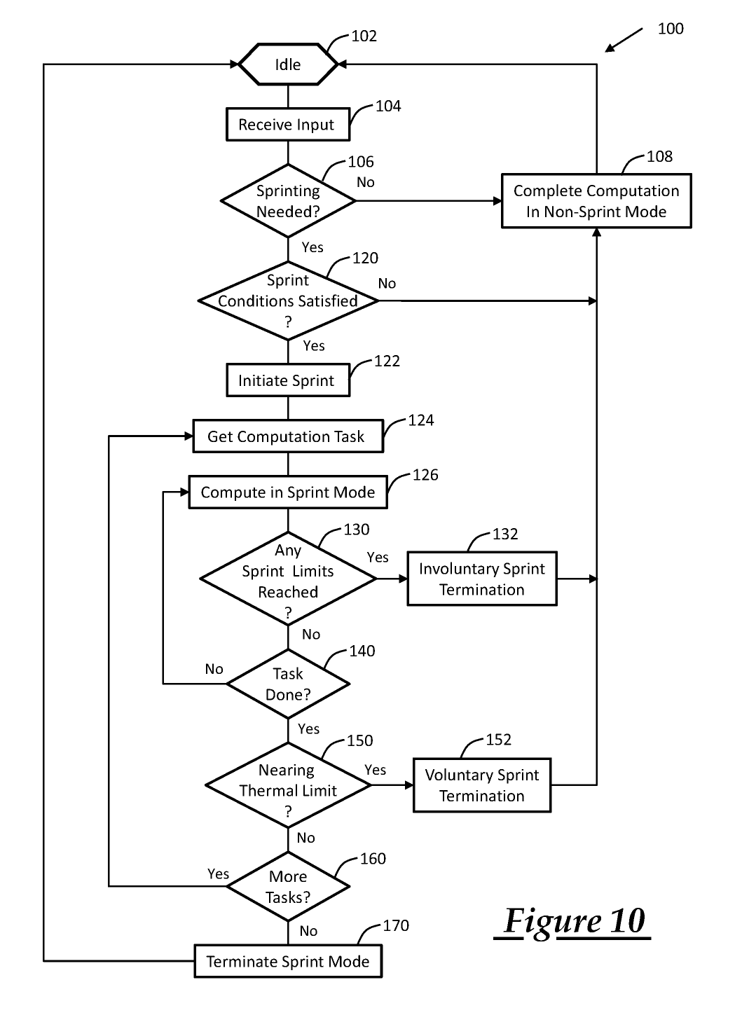

Further details of the sprint control circuitry are shown in FIG. 9. In general, the sprint control circuitry 60 may govern initiation, control and/or termination of the sprint mode, as well as activation and/or deactivation of the cores 12 according to one or more factors, such as the computational requirements placed on the IC or certain thermal conditions. Depending on the embodiment, the sprint control circuitry 60 may carry out a number of other functions such as task allocation among the cores 12 and control of supplemental power, such as from the supercapacitor 66. Also, operation of the IC device in the normal mode may be carried out using separate, in-package circuitry, or by the sprint control circuit 60 itself. Similarly, for other operational modes such as a cooling mode in which the cores 12 may be operated in reduced numbers or at a reduced frequency or operational level to reduce heat generation and speed up cooling of the device. The sprint control circuitry 60 may receive and utilize any relevant input that is useful in initiating, managing, and terminating the sprint mode, some of which are shown in FIG. 9. For example, received software instructions (i.e., processing tasks) indicative of the computational demand on the IC device may be received and/or monitored by the sprint control circuitry 60 and used to determine whether and how to initiate the sprint mode.

The thermal capacity of the multi-core processing system 30, the package 10 and/or any components may be supplied to the sprint control circuitry 60 as an input from some other circuitry or source of this information, or may be derived or calculated by the sprint control circuitry 60 itself using one or more inputs such as a die or core temperature input or as a package temperature input indicative of the temperature of the thermal interface 20 or other portion of the system. Separate temperature inputs may be supplied from separate cores 12 or dies 14 within the package 10, or a single such temperature reading may be supplied. Alternatively or additionally, an input representative of the state of the thermal capacitor(s) 22 may be provided to the sprint control circuit 60; for example, temperature or, in the case of a phase change material, the phase of the material. Apart from thermal capacity, inputs concerning the health or status of the available electrical power may be supplied and used as well. In some embodiments, this may involve a reading of the voltage level of the input power (voltage rail) supplied to the device. This inputted supply voltage may be used to determine the state of charge of a power supply, or even to determine the type of available power being supplied (e.g., utility power v. battery). For example, some aspect of the inputted voltage might be characteristic of a different power source type, such as absolute voltage level, detected changes in voltage level (e.g., a slowly dropping voltage indicative of battery discharge), noise on the input supply (e.g., indicating a utility line supply), etc. For some of these approaches, an unregulated input that bypasses the voltage regulator 72 may be used. In other embodiments, the PMU 70 may provide a power supply type signal specifically indicating what source is being used by the PMU 70 to deliver operating power.

While temperature may be used in some embodiments as the primary determiner of available thermal capacity, other embodiments may use a more intelligent process, some involving thermal models of the device or components thereof and/or involving historical performance and/or using other activity monitors to estimate thermal loading of the device. For example, activity monitors based on current draw, battery utilization, and instruction count may be used to estimate available thermal capacity, and this may be done in combination with the temperature information available from the core(s) 12, die(s) 14 or package 10 itself. Those skilled in the art will be aware of how to estimate thermal capacity and thermal load based on such factors. Conservative time-based estimation (static thermal model), coupled with a worst-case or average-case power dissipation may be used for this. In some embodiments, this computation of thermal capacity may be performed and used solely by the sprint control circuitry 60 to control the sprint mode. In other embodiments, it may be made available to operating system or other software (e.g., executing application software) through control/status registers or other such handshake mechanisms. This would allow external software monitoring and control of the sprint mode initiation and termination.

As indicated in FIG. 9, some of these inputs are external inputs received from other devices or components, whereas some are generated in-package. Any combination of external and internal inputs may be used. Moreover, it should be appreciated that any combination of the inputs, readings, information, estimates, etc. that are described above and pertain to the thermal state or capacity of the multi-core processing system 30, or any of the components of the system, may be used by the sprint control circuitry 60 as a “thermal condition” during the initiation, management and/or termination of the sprint mode.

Given all of the inputs, the sprint control circuitry 60 determines when to initiate the sprint mode as well as when to when to terminate it. In some embodiments, the sprint mode interval may be a fixed interval determined to be short enough in time so as to not exceed the expected thermal capacity. In other embodiments, the sprint interval is determined individually each time it is initiated and the sprint mode is then ended after the determined elapsed time has gone by. In yet other embodiments, the length of the interval is not specifically determined, but rather one or more of the inputs are monitored during the sprint mode operation and an execution time decision is made when to exit the sprint mode. In initiating, managing and/or terminating the sprint mode, the sprint control circuitry 60 may determine which cores to activate/deactivate, as well as to how to assign computational tasks to the individual cores. The in-package circuitry (either on or off the die) includes voltage rails that supply power to the various cores 12 and the sprint control circuitry 60 and may include power gating that enables the sprint control circuitry to power (activate) and unpower (deactivate) the cores used for sprinting. The deactivated cores may be partially or completely powered down (e.g., either into an unpowered state or into a low-power quiescent state).

FIG. 10 is a flowchart showing one embodiment of a method 100 for carrying out sprint mode operation. At idle the IC device may operate in its normal mode, step 102, either waiting for a task input or carrying out various idle mode tasks, as will depend on the particular type of electronic computing device in which the IC package is being used (e.g., in a mobile phone versus a fixed computer). Then, upon receiving an input in step 104, such as one or more processing tasks, the sprint control circuit 60 determines whether operation in the sprint mode is needed, step 106. This may be done in various ways; for example, predictively, based on a stored history of sprint-intervals and thermal capacity, or predictively, based on the size and parallelism in the received workload, or explicitly, based on specific instructions and/or parallel constructs in the received software, or in any combination of these. Thus, in addition to the different ways of determining when to initiate the sprint mode, the site or location at which this initiation occurs may vary from one implementation to the next or even within the same implementation. For example, the sprint mode may be initiated by hardware, by the application software being executed, by a runtime environment, or by the operating system used on the device hosting the IC package.

If sprinting is not needed, then the inputted task(s) are completed in a non-sprint mode at step 108, such as the normal mode wherein only one or a few cores are operated at a level that will not exceed TDP even if sustained for long durations. If sprinting is needed, a check is then made to determine if the conditions for sprinting are satisfied, step 120; for example, this step could determine if sufficient thermal capacity and satisfactory power conditions exist. If conditions are not appropriate, then the task(s) are completed in the normal or other non-sprint mode, step 108. If conditions are suitable, then the sprint mode is initiated in step 122, which may involve activating a number of processing cores 12 within the multi-core processing system 30 and establishing operating parameters for the activated cores (e.g., setting operating frequency/voltage of the active cores) in order to provide high responsiveness to the requested tasks in a short enough period of time so as to not increase the heat above safe levels. Although the process shown in FIG. 10 indicates a somewhat serial processing of multiple tasks, it will be appreciated that multiple tasks may be carried out simultaneously using different cores, or individual tasks may be distributed among two or more cores for faster individual task processing, or some combination of these. The following description is generally directed to an exemplary process of parallel sprinting where short bursts of additional computational activity are accomplished by activating one or more reserve cores; however, it should be appreciated that much of the disclosure provided herein is also applicable to frequency sprinting or a combination of parallel and frequency sprinting as well. Various suitable processing approaches that may be used in the sprint mode are discussed below.

Upon entering the sprint mode at least one computation task is obtained, step 124, and allocated as appropriate using the total number of operating cores activated for the current instance of the sprint mode. In some embodiments, all cores may be utilized when the sprint mode is started. In other embodiments, this total number of cores to be used during sprinting may be chosen either at the beginning of the sprint mode or may be activated as tasks are scheduled or assigned. For example, the computational requirement of incoming or queued tasks might be sufficient to initiate the sprint mode, but not sufficient to require all cores. Or, the number of cores may be explicitly identified, such as by request from the application software, runtime environment, or operating system. Or such explicit identification may be used in conjunction with other information such as the determined available thermal capacity. The number of cores to utilize may also be determined in part or in whole based on factors such as the amount of parallelism in the workload or history of past sprint mode operations. Selection of which cores to use may be done using available information including current operating parameters, thermal conditions and/or historical information such as prior utilization of one core versus another. Operational parameters for this might include, for example, temperature differences between cores or different sections of the die, such that cores in a lower temperature region of the IC package might be selected and activated before cores in a higher temperature part.

The one or more tasks are then executed in the sprint mode, step 126. Any suitable processing approach for allocating, scheduling, assigning, balancing, dequeuing and/or otherwise managing individual or multiple tasks between the cores may be used. Incoming tasks may be queued for handling sequentially or separate process threads may be instantiated as each task arrives. A task-based parallelism approach may be used in which a task scheduler is initiated after the cores are activated. In this approach, the scheduler may be initiated immediately following activation of the additional cores. In another embodiment, the task scheduler may be initiated at the beginning of the sprint mode before some or all of the additional cores are activated and can itself initiate core activation as a part of allocating tasks. Other task parallelism approaches may involve work stealing or work dealing scheduling from a per-core or global task queue. The sprint control circuitry 60 may include support for re-entrant or resumable tasks either in hardware, the operating system, or the runtime environment, or any combination of these.

Instead of or in addition to task parallelism, a thread-based parallelism approach to computational distribution between the cores may be used. Any suitable processing approach for allocating, scheduling, assigning, balancing, dequeuing and/or otherwise managing individual or multiple threads between the cores may be used. For example, using a standard threading library such as POSIX. The thread scheduler may be managed by the sprint control circuitry 60 hardware or by the runtime environment or operating system. The scheduler may be used to handle thread migration to and from the additional cores used in the sprint mode. Alternatively or in addition, thread management may be handled directly by the application software, supported by the threading library. As another parallel processing approach, an implicit fork join parallelism may be used, providing a mechanism for automatic detection of parallel sections in workloads to spawn and schedule threads using either the task-based parallelism or thread-based parallelism described above. Implementations of these varying approaches to distributed and parallel processing will be known to those skilled in the art.

Sprint mode operation in step 126 may be carried out in one of a number of different ways. According to one potential embodiment, step 126 utilizes a sprint pacing technique during the sprint mode that controls or adjusts the intensity of computational sprinting (e.g., the frequency and/or voltage of the active cores), as opposed to employing a constant or static intensity sprint for the entire sprint mode. Testing has shown that for relatively short computations maximum-intensity sprinting usually maximizes the responsiveness or performance of the multi-core system, and for intermediate computations it is preferable in terms of responsiveness to operate the active cores at some intermediate-intensity level that is less than maximum-intensity yet greater than minimum-intensity. The same generally holds true with human runners and intermediate distances—it is better to sprint at a slower pace for longer duration than to sprint at maximum pace for an extremely short duration. In this scenario, an intermediate-intensity sprint typically completes more work than a corresponding maximum-intensity sprint for at least three possible reasons. First, lowering the frequency and voltage results in a more energy efficient operating point, so the thermal capacitance consumed per unit of work is lower. Second, the longer sprint duration allows more heat to be dissipated to ambient during the sprint. Third, maximum-intensity sprints are usually unable to fully exploit all thermal capacitance in a heat spreader or other thermal component because the lateral heat conduction delay to the extents of the copper plate is larger than the time for the die temperature to become critical. By sprinting less intensely, more time is available for heat to spread and more of the device's thermal capacitance can be exploited.

There are a number of techniques that may be utilized by step 126 in order to carry out sprint mode operation, including predictive sprint pacing, adaptive sprint pacing, and sprint-and-rest techniques. In predictive sprint pacing, the length of the computation is predicted in order to select a near-optimal sprint pace or intensity. Such a prediction could be performed by the hardware (e.g., sprint control circuitry 60), operating system, or with hints from the application program directly. For instance, a predictive sprint pacing technique can include the steps of: estimating the length of one or more tasks, selecting a sprint pace based on the estimated length of the one or more tasks, and operating a select number of processing cores according to the selected sprint pace. Of course, other factors like thermal conditions, available power, etc. could also be considered when choosing an optimal sprint pace for the sprint mode.

In the absence of such a prediction, an alternative approach is adaptive sprint pacing in which the sprint pace dynamically adapts or adjusts to capture the best-case benefit for short computations, but moves to a less intense sprint mode to extend the length of computations for which sprinting improves responsiveness. According to one example of an adaptive sprint pacing technique, a multi-core processing system operates all of the active cores at a maximum-intensity sprint pace (i.e., operating at full frequency/voltage), monitors and determines when a thermal condition of the system reaches a certain threshold (e.g., 50% of the thermal capacity of the system is consumed), and once the threshold is met the adaptive sprint pacing algorithm transitions one or more of the active cores to a less intense and more power-efficient sprint pace—one way of accomplishing this is by throttling the frequencies of the active cores to a lower level. Stated differently, this adaptive sprint pacing technique does not necessarily change the number of active cores during the computation, but instead adjusts the frequency of the active cores by lowering them at a certain point that is based on thermal capacity. This technique may capture the benefits of sprinting for short bursts but maintains some responsiveness gains for longer computations. The optimal sprint pace and the transition point at which the sprint pace is adjusted can be impacted by a number of factors, including the length of the computation (most basic factor) or a thermal condition, as well as the performance and power impact of both the clock frequency and the number of active cores. For example, a workload that has poor parallel scaling may benefit more from higher frequency than additional cores. In systems with a relatively small number of cores and workloads that scale well, such effects may be second order, but they will likely become more significant as the number of cores on a chip increases.

Another potential technique for use with sprint mode operation is a sprint-and-rest technique, in which the sprint mode alternates between sprint and rest periods. Provided that the sprint periods are short enough to remain within temperature constraints, and that the rest periods are long enough to dissipate the accumulated heat, such a sprint-and-rest mode of operation can be quite sustainable. That is, sprint-and-rest operation is usually sustainable as long as the average (but not necessarily instantaneous) power dissipation over a sprint-and-rest cycle is at or below the platform's sustainable power dissipation or thermal design power (TDP). Testing has revealed that some multi-core processing systems can enjoy somewhat lower average power consumption, in addition to improved responsiveness or performance, by utilizing a sprint-and-rest technique. Sprint-and-rest generally outperforms TDP-constrained sustained operation because the instantaneous energy efficiency of multi-core operation is better than single-core operation; for example, operating all four cores of a quad-core system provides quadruple the performance at double the power. One potential explanation is that quad-core operation amortizes the fixed power costs of operating the chip over more useful work. Generally speaking, sprint-and-rest techniques will provide a net efficiency win when the instantaneous energy-efficiency ratio of sprint vs. sustainable operation exceeds the sprint-to-rest time ratio required to cool. The advantages of sprint-and-rest may grow even larger if the idle power of the chip is reduced.

It should be appreciated that any of the exemplary techniques listed above for operating a multi-core processing system in a sprint mode, as well as other techniques that would be known to persons of ordinary skill in the art, may be employed. It is also possible for the method to utilize a combination of such techniques or processes during the course of a single sprint mode cycle or across different sprint mode cycles, as opposed to always operating the sprint mode according to a single technique. For example, sprint mode operation may be carried out using both parallel and frequency sprinting techniques, predictive and adaptive sprint pacing techniques, predictive sprint pacing and sprint-and-rest techniques, adaptive sprint pacing and sprint-and-rest techniques, or any other combination of these and other sprint mode techniques, including utilizing any of the above-listed techniques by themselves.

To permit communication between the cores during parallel computation, the sprint control circuit 60 or IC device generally may include shared memory with hardware managed coherent caches, non-coherent shared memory, optionally supporting either the hardware or software managed coherence, or where no shared memory is used, may include support for explicit message passing and data flow between cores. Those skilled in the art will be aware of suitable multi-processor architectures to provide these features either on the die(s) containing the processor cores.

With continued reference to FIG. 10, while in the sprint mode, the process monitors to determine if any of the sprint limits are reached, step 130. For example, the method may determine if the thermal capacity of the system has been exhausted or if any of the other thermal conditions listed above have reached some threshold, or if there is a detected change or degradation in supplied electrical power. If such thermal limits or any other sprint limits occur, then there is an involuntary sprint mode termination at step 132, with the remainder of the task(s) being carried out in a non-sprint mode 108. Normal mode or cooling mode operation, for example, could be performed in step 108. The thermal and electrical condition check may be carried out using software or in hardware. A computational sprint that ends due to thermal limits before the task being performed is completed is referred to herein as a “truncated sprint.” Ideally, all tasks would be completed before the thermal conditions of the system reach their corresponding thresholds, however, this is not always the case. It is not uncommon for certain tasks to require a level of computational activity that causes the thermal or other sprint limits in step 130 to be exceeded, such that the method must exit the sprint mode before the task is complete in order to avoid the system overheating. In step 132, the method transitions from the sprint mode to a cooler mode of operation so that some of the accumulated heat in the system can be dissipated. There are a number of ways in which the method can perform such a transition, including reducing the number of active cores, reducing the sprint intensity (i.e., reducing the frequency/voltage) of the active cores, or a combination of both. In one example, step 132 migrates the various tasks and/or threads so that they are multiplexed to a single active core, and then reducing the operating frequency of that core. In other examples, it may not be necessary to limit the activity to a single core, but only to reduce the number of active cores. Other possibilities certainly exist for implementing or carrying out step 132, as that step is not limited to the examples provided here.

If no sprint limits have been reached in step 130, then task processing continues in the sprint mode until completed, step 140. A computational sprint such as this, where the task being performed is completed entirely during a sprint cycle without exhausting the system's thermal capacity, is referred to herein as an “unabridged sprint.” In most cases of unabridged sprints, the best performance or responsiveness is obtained by running all of the available cores at a maximum intensity during the sprint mode, and the best energy efficiency is achieved by running all of the available cores at a minimum intensity during the sprint mode. The various cores do not necessarily have to be operated at either a maximum or a minimum intensity, as it is possible to manipulate or control the intensity (e.g., the frequency/voltage) of the cores during the sprint mode, as explained above in connection with the various sprint pacing techniques.

Next, the system may optionally check to determine if the multi-core processing system is near its thermal limit or other thermal constraint, step 150. If so, then a voluntary termination is carried out in step 152 rather than processing more tasks so as to avoid hitting the thermal limit. If there is still a sufficient amount of thermal capacity remaining in the system, then either the process continues in the sprint mode to process additional tasks, step 160, or is terminated if all tasks are complete, step 170. Other than reaching an operational limit like a thermal constraint or completing all tasks, termination of the sprint mode may be done in response to a software notification that may or may not be tied to completion of individual process threads, and this notification may come from the application software being executed, from the runtime environment, or from the operating system. In one example, step 170 utilizes one or more of the techniques described in connection with the involuntary sprint mode termination of step 132. This may include, for example, implementation of a cooling mode.

Actual termination of the sprint mode in step 170 may involve a hardware initiated thread migration to the one or more cores used during normal or other non-sprinting modes. Alternatively or in addition to this hardware approach, a runtime environment or operating system initiated thread migration may be used. In some implementations, re-startable tasks not completed on a core when deactivated may be re-started on the operating core(s) in the normal mode, rather than being migrated mid-process. Other such approaches to sprint mode termination and variations of these will become apparent to those skilled in the art.

Speaking in general terms, some tests results suggest that computational sprinting can provide not only improvements in responsiveness or performance, but also gains in net energy efficiency by racing to idle. Even for extended computations, a thermally constrained sprint-enabled chip can achieve better performance through sprint-and-rest operation rather than sustained execution within TDP. One of the central insights underlying these seemingly counterintuitive results is that chip energy efficiency is maximized by activating all useful cores—disregarding thermal limits—to best amortize the fixed costs of operating at all. There also appears to be a synergy between task-based work stealing parallelism and sprinting; by dissociating parallel work from specific threads, this approach may give the runtime the freedom it needs to manage sprint pacing and avoid oversubscription penalties for truncated sprints.

It is to be understood that the foregoing description is of various embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” and “such as,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of activating cores in a multi-core processing system, comprising the steps of:
processing one or more tasks while operating in a first mode by using a subset of a plurality of processing cores that are part of the multi-core processing system;
operating in a second mode by using additional cores from the plurality of processing cores, the additional cores are operated in response to an increased computational requirement such that heat produced by the operating cores when running in the second mode is in excess of one or more thermal constraints of the system; and
terminating the second mode of operation based at least in part on a thermal condition.

2. The method set forth in claim 1, wherein the operating step further comprises absorbing some of the produced heat using at least one thermal capacitor located in the multi-core processing system.

3. The method set forth in claim 1, wherein the operating step further comprises absorbing some of the produced heat using a phase change material located in the multi-core processing system.

4. The method set forth in claim 1, wherein the operating step further comprises absorbing some of the produced heat using a plurality of different phase change materials located in the multi-core processing system, the different phase change materials having different melting points.

5. The method set forth in claim 1, wherein the operating step further comprises absorbing some of the produced heat using a plurality of different phase change materials including a first phase change material located within an integrated-circuit package and a second phase change material located externally of the integrated-circuit package.

6. The method set forth in claim 1, wherein the operating step further comprises determining that the state of charge of a power source is above a threshold value and thereafter switching from the first mode to the second mode based at least in part on the determination.

7. The method set forth in claim 1, wherein the operating step further comprises providing supplemental power to at least some of the plurality of processing cores from a supercapacitor during the second mode.

8. The method set forth in claim 1, wherein the multi-core processing system includes a thermal interface that is thermally coupled to the plurality of processing cores and that is used to dissipate heat to an external heat sink, and wherein the one or more thermal constraints of the system includes a thermal design power (TDP) value representative of the maximum amount of heat that can be dissipated from the system via the thermal interface, and wherein the operating step further comprises operating the additional cores such that heat produced by the operating cores when running in the second mode is in excess of the TDP.

9. The method set forth in claim 1, wherein the operating step further comprises determining that a measured temperature within the multi-core processing system is below a threshold value and thereafter switching from the first mode to the second mode based at least in part on the determination.

10. The method set forth in claim 1, wherein the thermal condition is dependent at least in part on one or more predicted or sensed parameters.

11. The method set forth in claim 10, wherein the one or more parameters comprise any one or more of the following: temperature of one or more of the plurality of processing cores, temperature of an integrated circuit package, charge state of a battery, and whether power supplied to the processing cores comes from a battery or a utility power source.

12. The method set forth in claim 1, wherein the operating step further comprises operating in the second mode by using either task-based parallelism or thread-based parallelism to operate the additional cores.

13. The method set forth in claim 1, wherein the operating step further comprises operating in the second mode by using a hardware scheduler to distribute tasks between at least the additional cores.

14. The method set forth in claim 1, wherein the operating step further comprises operating in the second mode by using a software scheduler to distribute tasks between at least the additional cores, and wherein the software scheduler is executed as a part of an application process, runtime environment, or operating system.

15. The method set forth in claim 1, wherein the operating step further comprises utilizing a predictive sprint pacing technique during the second mode that includes estimating the length of one or more tasks, selecting a sprint pace based on the estimated length of the one or more tasks, and operating the plurality of processing cores according to the selected sprint pace.

16. The method set forth in claim 1, wherein the operating step further comprises utilizing an adaptive sprint pacing technique during the second mode that includes operating the plurality of processing cores according to a maximum-intensity sprint pace, determining when a thermal capacity of the multi-core processing system reaches a threshold value, and once the thermal capacity reaches the threshold value then operating the plurality of processing cores according to a sprint pace that is less than the maximum-intensity sprint pace.

17. The method set forth in claim 1, wherein the operating step further comprises utilizing a sprint-and-rest technique during the second mode that includes alternately operating the plurality of processing cores in sprint and rest modes, and wherein the average power dissipation over the sprint and rest modes is at or below the maximum sustainable power dissipation capability of the multi-core processing system.

18. A multi-core processing system, comprising:
a plurality of processing cores disposed together in a common package having a thermal interface for drawing heat from the package and having external leads for electrical connection to external circuitry, wherein the cores are thermally coupled to the thermal interface of the package;
core control circuitry coupled to at least some of the cores for selectively activating and deactivating the coupled cores;
wherein the package has an associated thermal design power (TDP) that is less than a combined power consumption of the plurality of cores when executing simultaneously for an extended amount of time; and
wherein the control circuitry operates to utilize a subset of the cores for regular continuous operation at a level of power consumption that is less than the TDP and, during periods of increased computational needs, operates to selectively activate additional ones of the cores at a total combined power consumption level that is in excess of the TDP and for a period of time that is limited such that the power consumption of the package does not exceed the TDP.

19. The multi-core processing system set forth in claim 18, further comprising at least one thermal capacitor located within the system, each thermal capacitor being associated with and thermally coupled to one or more of the cores to absorb heat from the associated cores.

20. The multi-core processing system set forth in claim 18, wherein each of the cores comprises a portion of a single die and further including a thermal capacitor thermally coupled to the die, wherein the thermal capacitor absorbs at least some of the heat produced by the cores in the die.

21. The multi-core processing system set forth in claim 20, wherein the thermal capacitor comprises a phase change material.

22. The multi-core processing system set forth in claim 21, wherein the phase change material comprises a first phase change material having a first melting point, and wherein the processing system further comprising a second thermal capacitor comprising a second phase change material having a different inciting temperature than the first phase change material.

23. The multi-core processing system set forth in claim 22, wherein the first thermal capacitor is located within the package and the second thermal capacitor is located externally of the package.

24. The multi-core processing system set forth in claim 18, wherein the plurality of cores and the core control circuitry are housed together in the package, whereby the multi-core processing system comprises a packaged integrated circuit.

25. A mobile device comprising the multi-core processing system of claim 18.

26. The mobile device set forth in claim 25, further comprising a power supply that supplies sufficient operating power to the multi-core processing system to operate all of the cores simultaneously.
